(19) United States
(12) Patent Application Publication
(10) Pub. No.: US 2018/0285129 A1
(43) Pub. Date: Oct. 4, 2018

(54) SYSTEMS AND METHODS FOR PROVIDING COMPUTER INTERFACE INTERACTION IN A VIRTUALIZED ENVIRONMENT

(71) Applicant: General Dynamics Mission Systems, Inc., Fairfax, VA (US)

(72) Inventor: Joseph Mangino, Annapolis Junction, MD (US)

(21) Appl. No.: 15/479,001

(22) Filed: Apr. 4, 2017

(51) Int. Cl. G06F 9/44; H04L 29/08; G06F 3/0481

(52) U.S. Cl. CPC G06F 9/4445; H04L 67/2842; H04L 69/16; G06F 3/0481; H04L 67/1095

(57) ABSTRACT

Systems and methods are provided for capturing screen contents of a plurality of applications. The applications operate on a processor-implemented device. The applications' screen contents are rendered for user interaction in a virtualized environment. A server continuously updates images of the windows of the multiple applications that are open for use within the virtualized environment.

### TECHNICAL FIELD

The technical field generally relates to computer interface interaction, and more particularly relates to using a virtualized environment for providing computer interface interaction for users.

### BACKGROUND

Virtual reality (VR) is an artificial, computer-generated simulation of a real-life environment or situation. It immerses the user by making the user feel as if they are experiencing the simulated reality firsthand, primarily by stimulating their vision and hearing through a sensor-packed wearable device, such as HTC's Vive™ virtual reality system. Augmented reality (AR) takes a user's view of the real world and adds digital information data on top of it. This might be as simple as numbers or text notifications, or as complex as a simulated screen.

Applications of VR and AR technology have allowed users to be inserted within a digital environment in varying degrees of immersion, such as within a gaming environment. However, applications of VR and AR technology to interacting with computer user interfaces and their associated programs have experienced technological limitations. This has resulted in a limited user experience in interacting with such applications within virtualized environments (e.g., virtual reality environments, augmented related environments, mixed reality environments, etc.).

### SUMMARY

In accordance with the teachings provided herein, systems, methods, apparatuses, non-transitory computer-readable medium for operation upon data processing devices are provided for capturing screen contents of a plurality of applications. The applications operate on a processor-implemented device. The applications' screen contents are rendered for user interaction in a virtualized environment. A server continuously updates images of the windows of the multiple applications that are open for use within the virtualized environment.

As another example, a system and method includes maintaining on a server a list of windows and their associated process identifiers. The windows are opened by user interaction and contain the screen contents of the applications. The server requests application render updates from a host machine using a messaging command that provides dynamic compression of the windows using the identifiers associated with the windows. The server continuously updates images of the windows of the multiple applications that are open, and caching, on the server, the images. The server asynchronously responds to requests for the images by serving the cached images for user interaction in the virtualized environment.

### DESCRIPTION OF THE DRAWINGS

FIG. 1 is a block diagram of an example virtualized desktop server;

FIG. 2 is a block diagram of an example virtualized desktop client;

FIG. 3 is a flowchart illustrating how in one embodiment a virtualized desktop server asynchronously updates bitmap representations of each open window being managed by the application;

FIG. 4 is a flowchart illustrating how in one embodiment a virtualized desktop server handles client requests and serves image representations of open windows;

FIG. 5 is a flowchart demonstrating how in one embodiment a virtualized desktop server's window manager starts, stops, and handles input for active windows;

FIG. 6 is a flowchart illustrating in one embodiment a main application (render) loop for the virtualized desktop client for sending input events to the server and scheduling draw calls;

FIGS. 7A and 7B illustrate in one embodiment a coordinate conversion to bring input events from a headset's three-dimensional space into a window's two-dimensional space;

FIG. 8 is a flowchart illustrating how in one embodiment a virtualized desktop client asynchronously requests up-to-date images for each open application;

FIG. 9 is a flowchart illustrating how in one embodiment a draw step takes three-dimensional position and rotation data for the active windows as well as their current textures to create a stereoscopic rendering which is output to a display device;

FIG. 10 is a block diagram of possible configurations for a virtualized desktop environment;

FIG. 11 is a block diagram of possible configurations for a virtualized desktop environment where a client interacts with multiple servers;

FIG. 12 is an example of visual output produced in an augmented reality headset running virtualized desktop environment; and

FIG. 13 is a flowchart showing the abbreviated process by which the headset produces a multi-application display in an asynchronous manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description.

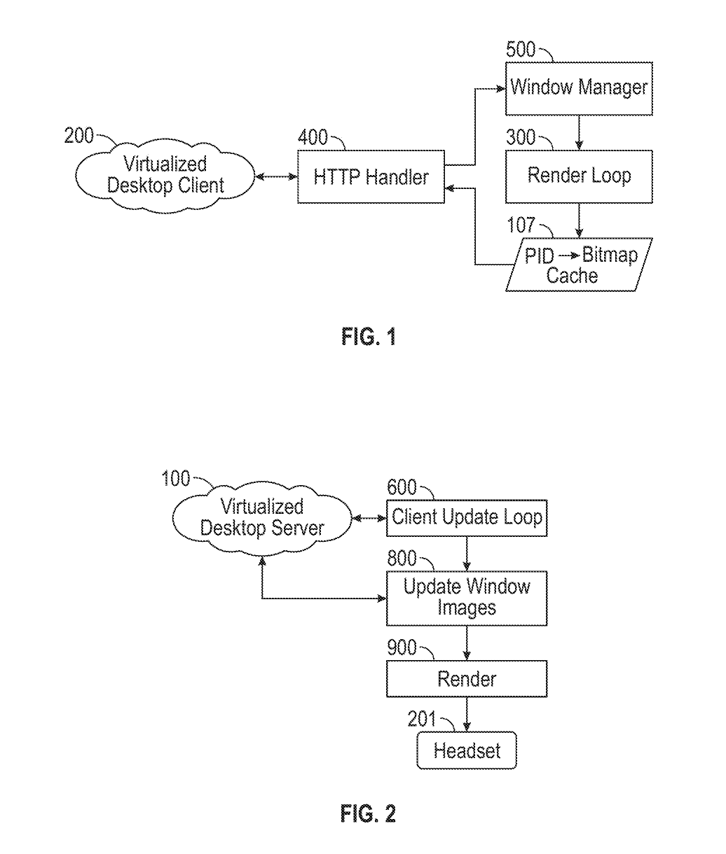

FIGS. 1 and 2 depict a virtualized desktop environment that takes renderings from running applications on a computer and renders them in an augmented or virtual reality headset or other device for interaction (e.g., manipulation) by one or more users. For example, the virtualized desktop system can provide the user with the ability to click on, open, resize, and close applications from the headset as well as many other operations.

With reference to FIG. 1, the virtualized desktop environment includes a virtualized desktop server 100 and a virtualized desktop client 200. The modules on the virtualized desktop server 100 communicate with each other to serve up-to-date application images and listen for mouse and keyboard inputs. The virtualized desktop server 100 has an HTTP (Hypertext Transfer Protocol) handler 400 and a window manager 500. Each open window has a render loop 300 thread which writes data directly to the PID to bitmap cache 107, which is a data structure for the server 100. The PID to bitmap cache is an in-memory map which associates the PID (process identifier) to the most up-to-date (compressed) image associated with that running application. The server maintains this cache to immediately or substantially immediately respond to image requests (e.g., rendering windows before receiving the request, rather than after).

FIG. 2 details the diagram for how the virtualized desktop client 200 communicates with the virtualized desktop server 100 and produces images to display to the virtual or augmented reality display 201. The client 200 maintains an update loop 600 which sends and receives events to and from the virtualized desktop server 100. The update loop 600 will also trigger asynchronous requests to update window images at 800. The final step initiated by the update loop is rendering at 900 the windows. The produced 3D scene is displayed on the headset 201 at or near the hardware's screen refresh rate (e.g., varying by device, it can be sixty to ninety hertz, etc.).

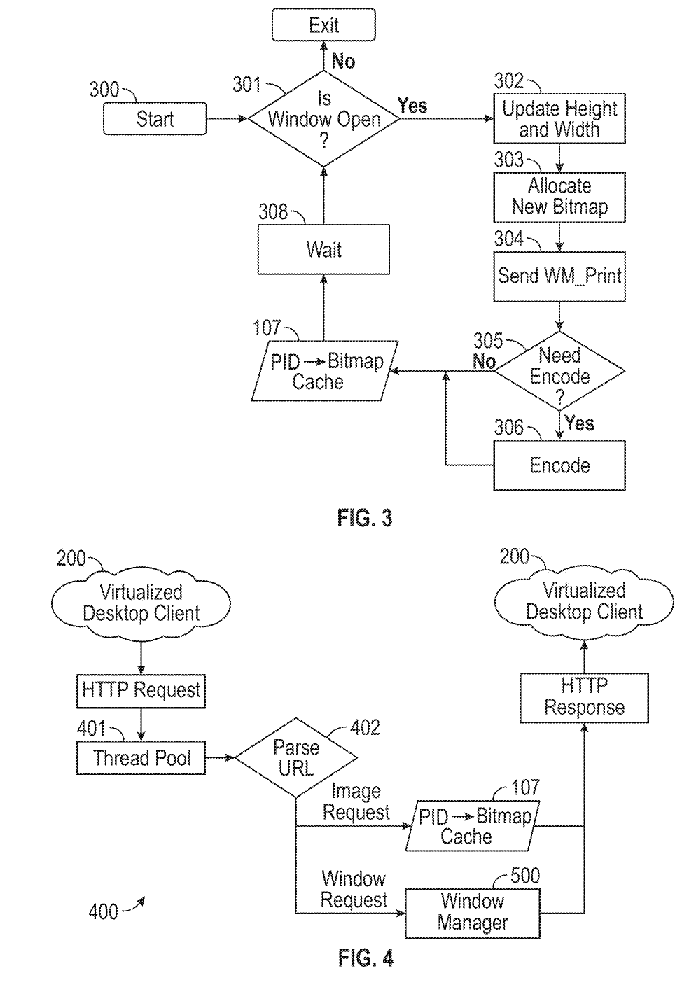

FIG. 3 details the process by which the virtualized desktop server 100 updates bitmap representations for each active window. This process is called the virtualized desktop server render loop 300, and each instance of this process will run on its own thread and has its own associated active window. First, the process checks if the window is open 301. A closed window will be discarded and the loop will stop. Next the process queries the host operating system for the window's dimensions (height and width) 302, as they might differ since the last frame. Heap memory is allocated for the new bitmap 303. The render loop 300 cannot directly access the video memory allocated to other processes. However, a request can be sent and the operating system or window framework copies the video memory to the local process. For example, in a Windows-based implementation, a WM_PRINT message is sent 304 to the active window. For Windows versions after 8.1 (6.3.9600), the WM_PRINT message is accompanied by the PW_RENDERFULLSCREEN flag. At this point the bitmap now contains the current rendering of the target window.

Next, the server checks if the client needs a specific encoding (GZIP, PNG (Portable Network Graphics), raw pixel binary, etc.) at 305. The client may request encoding/compression. If the client is only running one application at 600×1024 pixels with 3 bytes per pixel, refreshing at 10 frames per second—this would require 17.58 MB/s (600*1024 pixels*3 bytes per pixel*10 per second/1024² convert to megabytes). Having multiple windows open or refreshing at a high rate (unencoded) for high priority or high fidelity applications (like video) may needlessly tax the network. Furthermore, most applications compress very well because they have limited color palettes and significant empty space.

If no encoding is necessary, then processing resumes. If the client needs a specific format, the process encodes it at 306. The updated bitmap is written to the PID to bitmap cache 107. This write occurs synchronously because different threads could be serving (reading) the underlying image to clients during the update. The thread then waits at 308 depending on the required refresh rate or priority for the application. For example, if the window requires sixty hertz updates, the bitmap update occurs faster than 16.6 milliseconds (1 second/60 hertz*1000 convert to milliseconds). If the thread finishes the update in 12 milliseconds, it will wait for 4.6 milliseconds to maintain an exact refresh rate. This refresh rate is configurable.

FIG. 4 details the process by which the virtualized desktop server 100 handles HTTP (Hyper Text Transfer Protocol) requests. This process is called in this example the virtualized desktop server HTTP Handler 400. The virtualized desktop server may need to respond to two types of HTTP requests: requests for current window bitmaps and requests for window event updates. When the server receives a request, it handles the request by allocating a new thread from the thread pool 401. The thread starts by parsing the request's URL and HTTP headers 402 to determine how to handle it.

If the request is for the image of a window, the server performs a synchronous read from the PID to Bitmap Cache 107 (in case the specific bitmap is being updated from a render thread). The image will be sent to the client in the HTTP Response and the thread will close.

If the request is for sending an input event to a window, the pertinent information is parsed from the request (e.g., input type, coordinates, button, window, etc.) and sent to the window manager 500. The window manager attempts to perform the requested action and responds with either a success or error code in the HTTP Response.

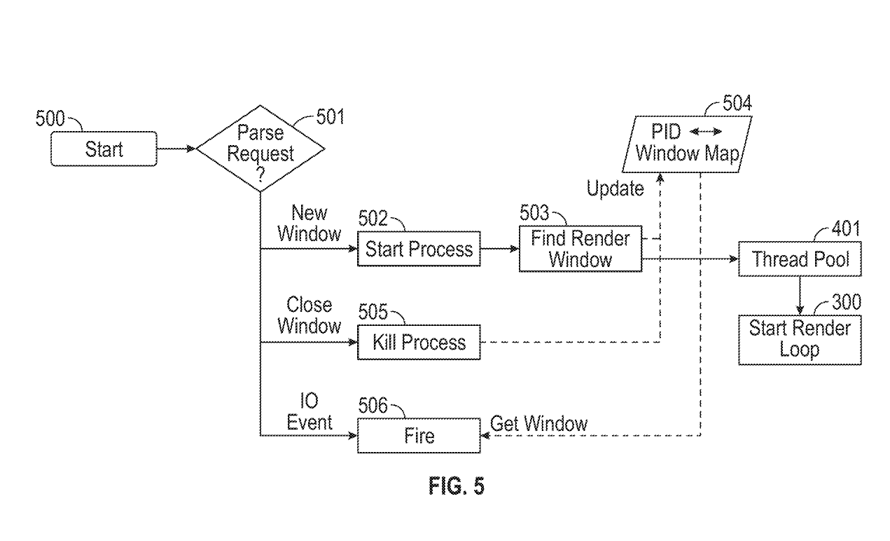

FIG. 5 details the process by which the virtualized desktop server's window manager 500 converts HTTP requests to system inputs (mouse, keyboard, etc.) and it can also handle opening and closing windows on the host system. The window manager 500 parses the request 501 to determine how to handle it.

If the request is for opening a new window, the window manager 500 begins by starting the requested process 502. On most operating systems, the rendered windows have different identifiers than the process id. Specifically, in the Windows operating system, processes with a visual component have a window handle. Furthermore, some processes will immediately spawn a child process and then exit, while the child process handles the rendering. Most applications will ask the user to select the appropriate window from a list of open windows, instead of launching an application and dynamically trying to resolve the handle. The window manager 500 compares the list of open windows before and after the process starts and the difference between the lists represents newly opened windows. If there are multiple new windows, the window manager 500 will also inspect the titles to find the right handle. This step relates to finding the window handle at 503 that is associated with the process that was started in 502. The PID to window handle map 504 is updated so that this conversion can be repeated later. A new thread is started from the thread pool 401, and that thread will execute its render loop 300 until the window is closed.

If the request is to close a window, the process is killed 505. The PID to window handle map 504 is updated accordingly. The associated render loop 300 thread will terminate on its next iteration.

If the request is to send an input event to a window, the appropriate window handle is retrieved from the PID to window handle map 504. In the Windows operating system, User32.dll can be used to fire the input event to the window at 506.

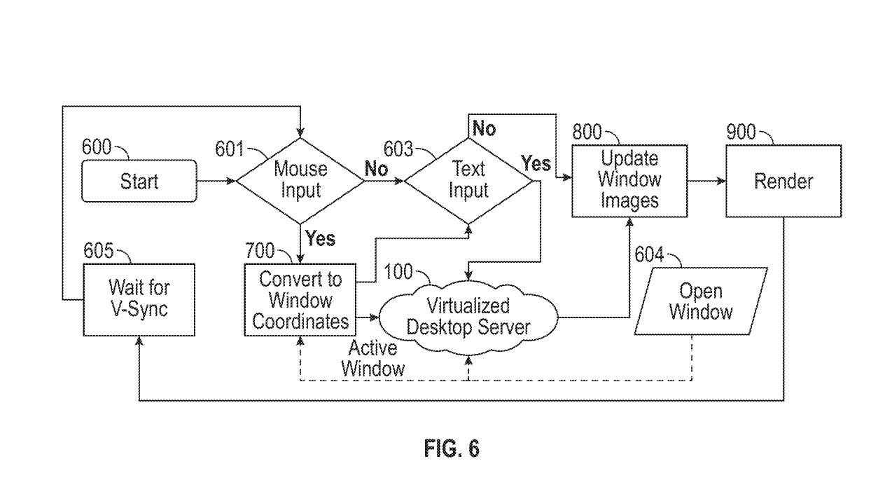

FIG. 6 details the update loop 600 running on the client. This loop (on its own thread) is responsible for sending updates to the virtualized desktop server 100 and initiating the asynchronous image updates for open windows 800. Furthermore, this loop initiates rendering 900 to create and send the 3D images to the headset. First, it checks if the user attempted to click a window 601. If it is, then the process converts the 3D pointer (e.g., mouse) coordinates to 2D screen space coordinates 700 for the host's window. The click request is sent to the virtualized desktop server 100. The client now checks if the user attempted a keyboard input on this frame 603. If so, the keyboard input is relayed to the virtualized desktop server 100. Both events are applied to the active window as determined from the open windows structure 604. This structure is an array of references to open windows.

Next, the update window images process 800 runs. After that, the update loop 600 will initiate the render process 900, to send relevant data to the GPU and produce an image for the output device (headset). The update loop 600 will wait for V-Sync 605 so that images are being sent to the output headset exactly as fast as the hardware refresh rate.

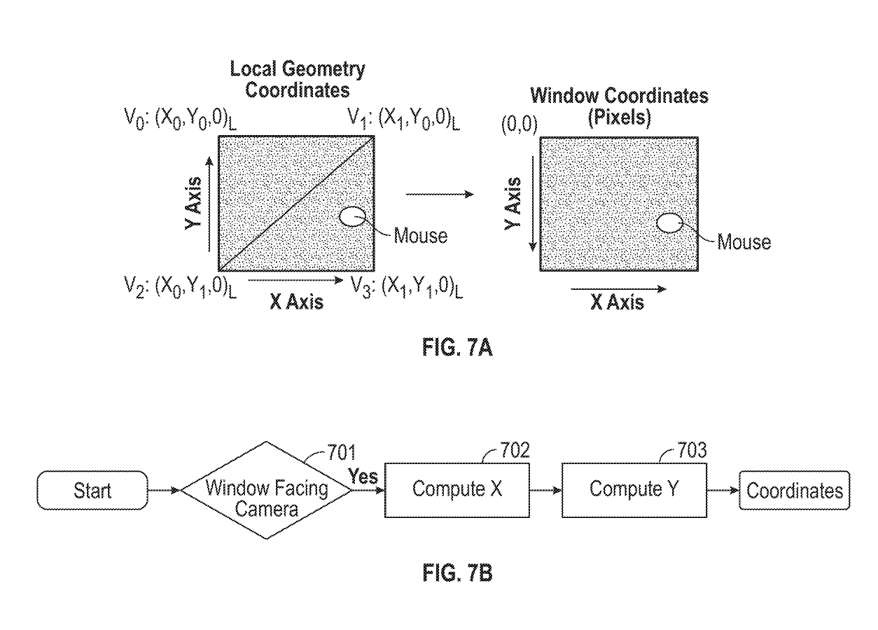

FIGS. 7A and 7B detail the method for converting 3D coordinates in the augmented reality scene to 2D system coordinates. In some embodiments, the axes may change orientation and direction. For example, the Y-Axis may change direction between 3D and 2D space. First there is a check to make sure the click is valid by seeing if the open window is facing the camera 701. In world space, the dot product is taken of the camera's view direction and the surface normal of the plane.

Using the equation:

∥\vec{u}∥∥\vec{v}*cos(θ)=\vec{u}·\vec{v}

This can be rewritten in terms of theta (the angle between the two vectors):

$$θ = {cos}^{- 1} ( \frac{\vec{u} \cdot \vec{v}}{‖ \vec{u} ‖ ‖ \vec{v} ‖} )$$

The plane's surface normal can be generated by multiplying (0, 0, 1, 0) by the associated model matrix to convert to world space. The plane-to-camera vector can generate the positions derived from the model matrices. For the plane, the camera yields the plane-to-camera vector. If the dot product of the plane-to-camera and surface normal vector is positive, they are facing the same direction.

The coordinate conversion may be done from local coordinate space for the 3D window (represented by a rectangle). The Z value of the vertices is 0. The bounding corners can be given by (X₀, Y₀, 0) and (X₁, Y₁, 0). Given the resolution of the windowed application (width and height) in pixels, the 3D mouse location can be converted from (Xₘ, Yₘ, 0) to 2D screen space using:

$$Compute X at 702 \text{:} x = width \times round ( \frac{{X}_{m} - {X}_{0}}{{X}_{1} - {X}_{0}} )$$

$$Compute Y at 703 \text{:} y = height \times round ( \frac{{Y}_{m} - {Y}_{0}}{{Y}_{1} - {Y}_{0}} )$$

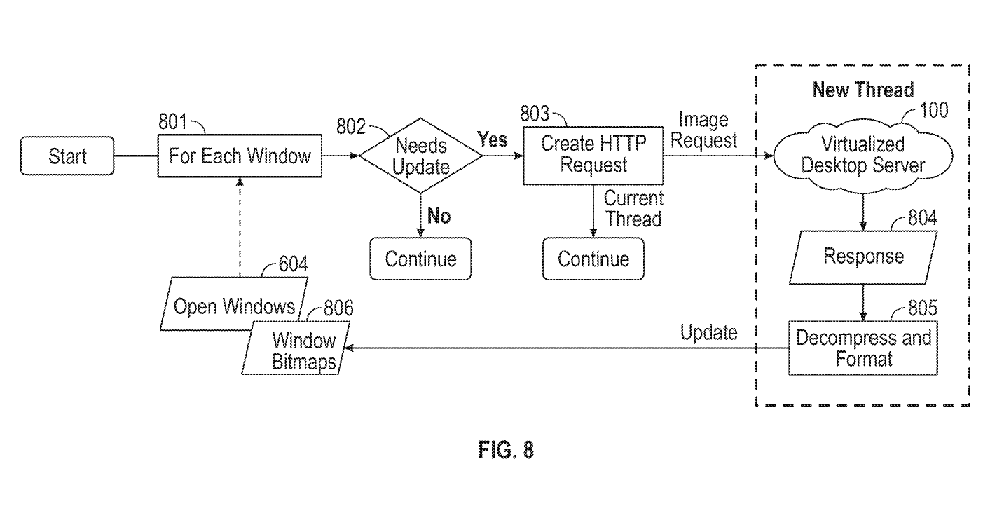

FIG. 8 details the steps the virtualized desktop client can use to update images at 800. The first step is to begin iterating through the windows 801 in the open windows data structure 604. The process checks if the window needs an update at 802. The need for updates is calculated (based on the time since the last update) using a priority system where certain applications will request updates more frequently than others. Further optimizations are made where windows receive fewer updates if they are on the periphery or outside of the headset 201 field of view.

If an update is needed, the process generates an HTTP request 803 with the identifying information for the current window (PID). The next steps can be handled on their own thread because networking and decompression may be too slow to occur on the main rendering thread (e.g., typically has less than 16 milliseconds to finish a loop). The request is sent to the virtualized desktop server 100, and the response 804 will be handled. The response image is processed at 805 as the data might be compressed or encoded. Additionally, the bits may need to be realigned due to underlying formats (e.g. Microsoft Windows bitmaps use BGRA—Blue, Green, Red, and Alpha. Many graphics languages use ARGB). The updated pixel array is synchronously written (in case the render loop thread is also reading) to the windows bitmaps 806 data structure.

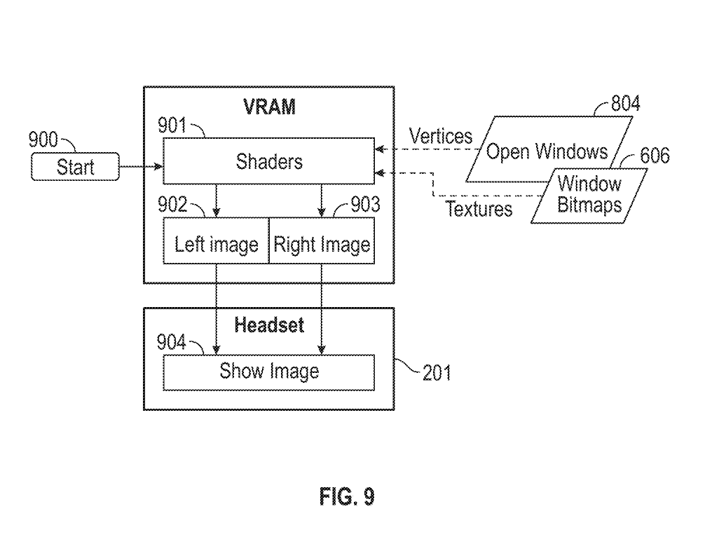

FIG. 9 details a draw 900 call by which all of the windows and the scene information are composited together to produce the image displayed at 904 on the virtual or augmented reality headset 201. The CPU binds the vertex buffer object representing the geometry for the open windows 604 to the GPU. The CPU also binds the textures from the window bitmaps 806 data structure. The shader programs 901 are also loaded on to the GPU.

A stereoscopic draw call is sent to the GPU to produce two images (left 902 and right 903 eye) for the associated scene information. These two images are output from the HDMI on the graphics card or by similar mechanism sent to the headset display 904.

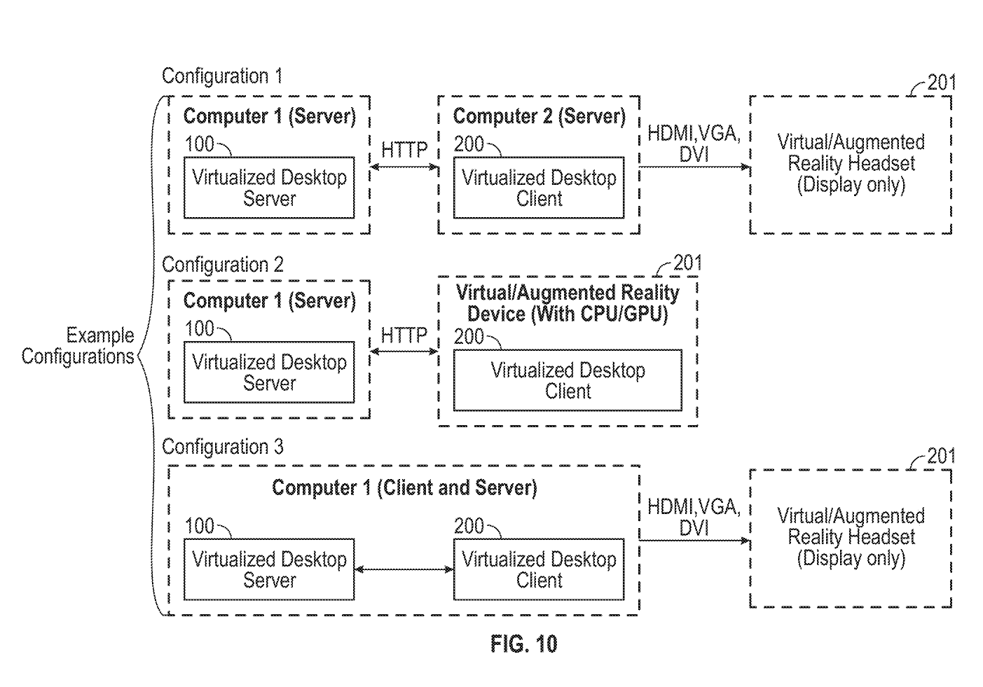

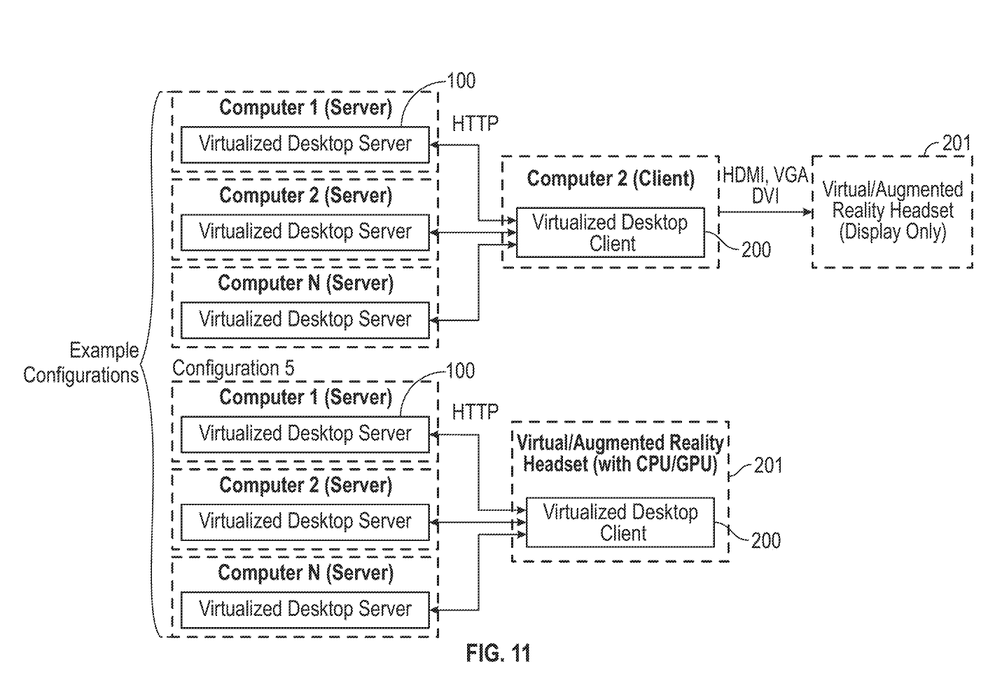

FIG. 10 details example configurations for using virtualized desktop environments. The configurations result from the following: the server 100 and client 200 can run on the same device and the client 200 can run on the headset 201.

Configuration 1 shows virtualized desktop server 100 and virtualized desktop client 200 running on separate computers that are networked together. This is an example of how a tethered headset may be used. Specifically, the headset does not have on-board computer and receives images over HDMI, VGA, DVI, or a different video cable.

Configuration 2 shows virtualized desktop server 100 and virtualized desktop client 200 running on separate computers. In this case, the headset is capable of running the client software directly and does not need to transfer the final display over a cable. An example of this type of hardware is the Hololens™ technology from Microsoft.

Configuration 3 shows a setup where the virtualized desktop server 100 and virtualized desktop client 200 are running on the same computer. In this situation, bitmaps can be transferred directly through memory instead of HTTP. Output images may be sent to the headset 201 over a cable.

FIG. 11 details potential configurations for a virtualized desktop environment where a client 200 is connected to multiple virtualized desktop servers 100.

Configuration 4 shows a virtualized desktop client 200 rendering multiple windows from multiple virtualized desktop servers 100. The servers do not need to be running the same operating system. The display is sent to the headset 201 over a display cable.

Configuration 5 shows a virtualized desktop client 200 Rendering multiple windows from multiple virtualized desktop servers 100. The servers do not need to be running the same operating system. The client may be running on the headset using hardware similar to the Hololens™ technology from Microsoft.

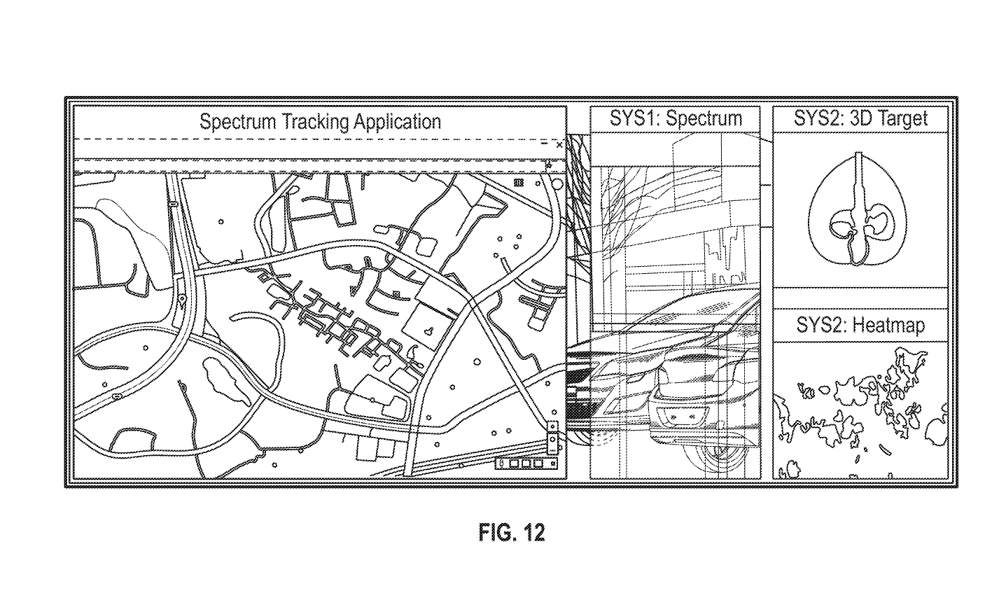

FIG. 12 shows example output from running the virtualized desktop system at 1201. In this example, the user sees four open windows which are being served from multiple virtualized desktop servers 100 on different computers. Each of these windows will update independently and the user can interact with them. Each rectangle represents a unique windowed application. The transparency relative to the outside world is configurable.

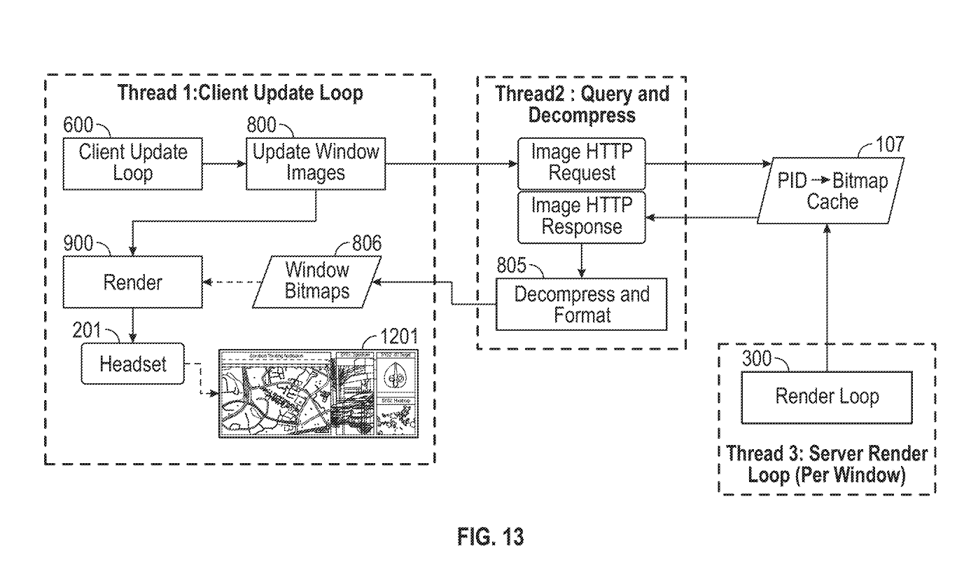

FIG. 13 shows how the asynchronous components of this application work together to update images quickly without impacting the performance of the main render loop 600. In this example, the abbreviated process results in a headset producing a multi-application display at sixty to ninety hertz in an asynchronous manner. This figure also illustrates how the images may move through the application and into the headset 201.

Each open window being managed by the virtualized desktop server 100 has its own thread constantly executing a render loop 300 and writing encoded/compressed updates to the PID to bitmap cache 107. In this manner, image requests do not wait for the calculations (e.g., the request can be handled immediately).

The update window images 800 also leverages asynchronous behavior. The networking and decompression 805 of images may also be too slow to handle on the main render thread. If multiple images need to update on the same frame, they each use their own thread.

From the perspective of the main render loop 600, the process requests updates and handles the GPU rendering. Meanwhile, the rest of the sub-systems write their data forward from the local memory in the server render loop 300 to the pid-bitmap cache 107 to the window bitmaps structure 806, where the client renderer 900 reads from. The effect is that the bitmaps being used to produce 3D output for the headset will always be up to date without demanding processing on the main render thread.

While at least one example embodiment has been presented in the foregoing detailed description, it should be appreciated that a vast number of variations exist. It should also be appreciated that the embodiment or embodiments are only examples, and are not intended to limit the scope, applicability, or configuration of the disclosure in any way. Rather, the foregoing detailed description will provide those of ordinary skill in the art with a convenient road map for implementing the example embodiment or embodiments. It should be understood that various changes can be made in the function and arrangement of elements without departing from the scope of the disclosure as set forth in the appended claims and the legal equivalents thereof. As an example of the wide variations of the systems and methods described herein, a system can be configured such that the virtualized desktop server maintains a list of windows (and their associated PIDs) opened by the user. The server requests application render updates from the host machine using a WM_Print message. In Windows versions 8.1 (6.3.9600) and later, the PW_RENDERFULLSCREEN flag is used. Because processes may render in a child process, a controller is used to determine the correct Window handle to issue WM_Print messages to. The server continually updates the bitmaps associated with the open windows and caches them. The server asynchronously responds to requests for current images by serving the latest cached value as the render time may be too slow to do during the request. In this example, images are served as Gzip—bitmap or PNG.

The virtualized desktop server may also listen for TCP/IP messages describing, keystrokes, mouse clicks, mouse moves, requests to open/close applications to provide interactivity with the images displayed to the client. The server converts these messages to operating system inputs and sends them to the associated applications.

The virtualized desktop client can operate on an edge device (e.g., a headset, a computer which provides rendering for the headset over HDMI/VGA/DVI/etc). In this example, the client sends requests to the server to open and interact with applications. At a rate of 20-30 Hz in this example, the client sends requests to the virtualized desktop server for an up-to-date rendering of all open applications. A rate of 1-60 Hz can also be used for a client to send requests to the server for an up-to-date rendering of all open applications. The rate can be based on a quality of service prioritization with respect to a user's field of view (e.g., based on what the user is currently viewing through a headset). To not interrupt the rendering loop, the client decompresses and/or decodes the images asynchronously into bitmaps representing pixels. As soon as decompression/decoding completes, the rendering loop sends the associated bitmaps to the GPU to be rendered on the next frame in the VR/AR device.

In this example, a full screen capture technique is used for rendering the entire desktop in VR or AR, and the WM_Print methods are used for application sharing in a non-VR/AR context and are used to capture an entire rendered screen. Additionally, real-time transfer of multiple applications from a server to an edge device are achieved for rendering multiple applications at the same time in Virtual and Augmented Reality.

A system and method can be configured as described herein to not render the entire desktop as a one-to-one pixel map which are almost transferred in memory as a single application instead of a client server model.

As another example of the wide variations of the systems and methods disclosed herein, the systems and methods can include utilization of the systems and methods for such uses as for office use, use by analysts, armored vehicles operators, submariners, pilots who have limited display space, etc.

Additionally, the systems' and methods' data (e.g., associations, mappings, data input, data output, intermediate data results, final data results, etc.) may be stored and implemented in one or more different types of computer-implemented data stores, such as different types of storage devices (e.g., memory) and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

Still further, the systems and methods may be provided on many different types of computer-readable storage media including computer storage mechanisms (e.g., non-transitory media, such as CD-ROM, diskette, RAM, flash memory, computer's hard drive, etc.) that contain instructions (e.g., software) for use in execution by a processor to perform the methods' operations and implement the systems described herein.

What is claimed is:

1. A method for capturing screen contents of a plurality of applications running on a processor-implemented device and rendering the screen contents of the applications for user interaction in a virtualized environment, said method comprising:
maintaining on a server a list of windows and their associated process identifiers, wherein the windows are opened by the user interaction and contain the screen contents of the applications;
continuously updating, on the server, images of the windows of the plurality of applications using a print message to generate the images using the process identifiers, and caching, on the server, compressed representations of the images;
receiving requests from a client to render updates for the windows; and
asynchronously responding by the server to requests for the images by serving the cached images for the user interaction in the virtualized environment.

2. The method of claim 1, wherein capturing, network transfer to a client, and decompression of images of the plurality of the applications are asynchronously performed and do not interrupt a rendering and updating loop on the client.

3. The method of claim 2, wherein the client displays the images of the multiple applications within the virtualized environment for the user interaction.

4. The method of claim 1, wherein the dynamic compression of the windows involves compressing the images of the windows prior to a request being sent by the client for the images of the windows.

5. The method of claim 1, wherein the images comprise bitmap images of screen shots of the windows that are open.

6. The method of claim 1 further comprising:
listening by the server for messages that describe keystrokes, mouse clicks, mouse moves, requests to open or close applications for providing user interaction with the images displayed to a client; and
converting by the server the messages from the user interactions with the plurality of applications displayed in the environment to operating system inputs and sending them to the associated applications.

7. The method of claim 6, wherein the messages are TCP/IP messages.

8. The method of claim 1, wherein the virtualized environment comprises an augmented reality environment, virtual reality environment, or a mixed reality environment.

9. The method of claim 1, wherein the user interaction includes clicking on, opening, resizing, and closing remotely served applications from a headset that generates the virtualized environment.

10. The method of claim 1, wherein the print message includes a WM_Print message that generates the images of the windows for dynamic compression.

11. The method of claim 1, wherein a client sends requests to the server to open and interact with the applications;
wherein at a rate of 1-60 Hz the client sends requests to the server for an up-to-date rendering of all of the open applications;
wherein the rate is based on a quality of service prioritization with respect to a user's field of view.

12. The method of claim 1 further comprising:
dynamically associating process identifiers with window handles;
wherein one or more of the processes render in child processes;
wherein a controller is used to determine a correct handle from the list of the process identifiers to issue the messaging commands;

13. The method of claim 12, wherein a data structure in memory contains the process identifiers to bitmap cache association and is an in-memory map which associates the process identifiers to the most up-to-date compressed representations of the images associated with running applications.

14. The method of claim 13, wherein the server maintains the cache to immediately or substantially immediately respond to image requests for rendering windows before receiving the request rather than after receiving the request.

15. The method of claim 1, wherein the client decompresses or decodes the images asynchronously into bitmaps representing pixels and does not interrupt a rendering loop on the client;
in response to completion of the decompressing or decoding, an update thread writes to a data structure shared by the rendering loop on the client that sends bitmaps to a graphical processing unit to be rendered on the next frame in the virtualized environment.

16. The method of claim 1, wherein the virtualized environment comprises an augmented or virtual reality headset.

17. The method of claim 16, wherein the headset is used to click on, open, resize, and close the applications.

18. The method of claim 1, wherein said asynchronously responding by the server to requests for the images results in a real-time transfer of multiple applications from the server to an edge device for rendering in the virtualized environment.

19. A system for capturing screen contents of a plurality of applications running on a processor-implemented device and rendering the screen contents of the applications for user interaction in a virtualized environment, said system comprising:
a storage device for storing instructions; and
one or more data processors configured to execute the instructions to:
maintain on a server a list of windows and their associated process identifiers, wherein the windows are opened by the user interaction and contain the screen contents of the applications;
continuously update, on the server, images of the windows of the plurality of applications using a print message to generate the images using the process identifiers, and caching, on the server, compressed representations of the images;
receive requests from a client to render updates for the windows; and
asynchronously respond by the server to requests for the images by serving the cached images for the user interaction in the virtualized environment.

20. A non-transitory computer readable medium having stored there on instructions for capturing screen contents of a plurality of applications running on a processor-implemented device and rendering the screen contents of the applications for user interaction in a virtualized environment that, when executed, cause one or more data processors to:
maintain on a server a list of windows and their associated process identifiers, wherein the windows are opened by the user interaction and contain the screen contents of the applications;
continuously update, on the server, images of the windows of the plurality of applications using a print message to generate the images using the process identifiers, and caching, on the server, compressed representations of the images;
receive requests from a client to render updates for the windows; and
asynchronously respond by the server to requests for the images by serving the cached images for the user interaction in the virtualized environment.
